(19) United States
(12) Patent Application Publication
(10) Pub. No.: US 2010/0114826 A1
(43) Pub. Date: May 6, 2010

(54) CONFIGURATION MANAGEMENT IN DISTRIBUTED DATA SYSTEMS

(75) Inventors: Santeri Olavi Voutilainen, Seattle, WA (US); Gopala Krishna Reddy Kakivaya, Sammamish, WA (US); Ajay Kalhan, Redmond, WA (US); Lu Xun, Kirkland, WA (US); Mark C. Benvenuto, Seattle, WA (US); Rishi Rakesh Sinha, Bothell, WA (US); Radhakrishnan Srikanth, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/511,644

(22) Filed: Jul. 29, 2009

Related U.S. Application Data
(60) Provisional application No. 61/108,076, filed on Oct. 24, 2008.

(51) Int. Cl. G06F 17/30

(52) U.S. Cl. 707/638; 707/E17.005

(57) ABSTRACT

Systems and methods for managing configurations of data nodes in a distributed environment A configuration manager is implemented as a set of distributed master nodes that may use quorum-based processing to enable reliable identification of master nodes storing current configuration information, even if some of the master nodes fail. If a quorum of master nodes cannot be achieved or some other event occurs that precludes identification of current configuration information, the configuration manager may be rebuilt by analyzing reports from read/write quorums of nodes associated with a configuration, allowing automatic recovery of data partitions.

### RELATED APPLICATIONS

This application claims benefit under 35 U.S.C. 119(e) of U.S. Provisional Application Ser. No. 61/108,076, filed on Oct. 24, 2008, the entire content of which is incorporated herein by reference.

### BACKGROUND

Advances in computer technology (e.g., microprocessor speed, memory capacity, data transfer bandwidth, software functionality, and the like) have generally contributed to increased computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. Today, a common approach is to store electronic data in one or more databases. A typical database can be referred to as an organized collection of information with data structured such that a computer program can quickly search and select desired pieces of data, for example. Moreover, in such environments a federation refers to a group of organizations or service providers that have built trust among each other and enable sharing of user identity information amongst themselves.

With the advent of distributed computing models such as web services, there are increased interdependencies among entities such as a Service Providers (SPs). Accordingly, a current trend is to focus on inter-organization and interdependent management of identity information rather than identity management solutions for internal use. Such can be referred to as federated identity management. In general, federated identity is a distributed computing construct that recognizes that individuals move between corporate boundaries at an increasingly frequent rate. Practical applications of federated identities are represented by large multinational companies that are required to manage several heterogeneous systems at the same time.

In such distributed systems, various challenges exist for proper management and configuration/reconfiguration of nodes. For example, individual nodes can fail randomly, which can cause data loss when suitable contingencies are not put into place. Likewise, replicated data is often required to be moved around the system, which can further create reliability issues and consistency problems.

Moreover, reliability issues can further complicate when data related to an over all management of such nodes are subject to loss due to failure of a centralized cache for example.

### SUMMARY

Data in a transactional data store may be replicated across many computers or other devices acting as nodes in a distributed system, such as for redundancy or high availability purposes. However, while the distributed system may provide a high guarantee of availability, the underlying computers on which the transactional data store is managed and replicated may themselves be unreliable.

The distributed system may be managed by a configuration manager that stores configuration information to enable identification of a data node or data nodes that store a current replica of the data store, or some partition of it. The configuration manager may be implemented as a set of master nodes that each maintain a copy of the configuration information. One of the master nodes in the set of master nodes may be designated as the primary master node for the configuration manager and responds to requests for configuration information and controls reconfiguration of the data nodes.

Quorum-based processing may be used to identify the primary master node as well as to determine whether a master node containing configuration information contains the current configuration information. Even if some master nodes that make up the configuration manager fail, if sufficient master nodes to identify a master node containing the current configuration information are available, reliable configuration information can be provided. In some embodiments, a sufficient number of master nodes is determined based on information stored in the master nodes themselves.

In some embodiments, each master node stores, in conjunction with configuration information, information identifying the set of nodes that makes up the configuration manager at the time that configuration information was stored. Because the configuration information is not committed in any master nodes unless a quorum of the set of nodes intended to be a new configuration can commit, if a quorum of the nodes in such a set agree that they contain the current configuration, the identified set can reliably taken as the current configuration. When a set of master nodes identifying the same group of master nodes as the current configuration manager represents a quorum of that group, the set can reliably be determined as the current set of nodes making up the configuration manager. Even if some of the master nodes making up the configuration manager fail, so long as a quorum of the master nodes stores consistent information identifying the current set of configuration information about the configuration manager, a reconstruction component can reliably identify a master node from which to obtain a replica of the current configuration information. The reconstruction component can also identify the master node designated as the primary master node in the current set and determine whether that primary master node is available. If primary master node has failed, a new primary master node can be designated and possibly additional master nodes can be designated as part of the set of master nodes storing current configuration information.

In scenarios in which a quorum of master nodes cannot be identified or there is some other catastrophic failure, the reconstruction component may reconstruct the configuration manager from information stored in the data nodes.

To reconstruct the configuration manager, a new primary master node may be selected by a process that identifies a node as the primary master node in a way that all master nodes recognize the same master node as the primary master node. In some embodiments, this process may involve communication among the primary master nodes, which may be managed by components of the database system that facilitate communication among the nodes.

In some embodiments, the communication among the master nodes may result in configuring the master nodes into a token ring in which a token is passed from node to node, assigning ordered positions to the master nodes. The new primary master node is selected as the master node with position 0. The token ring may also be used during system operation to identify failures in any master node will be identified by nodes in the token ring adjacent a failed node when the adjacent nodes cannot exchange a token with the failed node.

Once a primary master node is established, configuration information may be reconstructed from information stored in the data nodes. The data nodes in the distributed system may provide messages to one or more of the master nodes (e.g., the primary master node) indicating the data nodes, including a primary data nodes, storing a replica of the current configuration.

The messages from the data nodes are compared to identify a quorum of data nodes that report the same current configuration. When a set of data nodes identifying the same group of data nodes as storing the current configuration represents a quorum of that group, the set can reliably be determined as the set of data nodes making up the current configuration. Messages can be processed for each partition of the data set stored in the data nodes, allowing the configuration manager to be rebuilt with configuration information identifying the nodes storing a current replica of each partition, including a primary node for the partition.

The foregoing is a non-limiting summary of the invention, which is defined by the attached claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a reconstruction component according to some embodiments of the invention;

FIG. 2 illustrates an exemplary partitioning and a rebuild associated with a plurality of nodes according to some embodiments of the invention;

FIG. 3 is a block diagram of a system with a configuration component that can be reconstructed according to some embodiments of the invention;

FIG. 4A illustrates a methodology of setting a new configuration according to some embodiments of the invention;

FIG. 4B is a flow diagram of a method for managing a distributed system using a master cluster according to some embodiments of the invention;

FIG. 4C is a flow diagram of a method for rebuilding configuration information for a partition of the database according to some embodiments of the invention;

FIG. 5 illustrates an exemplary environment for implementing various aspects of some embodiments of the invention; and

FIG. 6 is a schematic block diagram of a sample computing environment that can be employed for data retrieval according to some embodiments of the invention;

### DETAILED DESCRIPTION

The inventors have recognized and appreciated that improvements in cost and reliability of distributed database systems may be achieved through an improved configuration manager that maintains configuration information for a distributed data store.

The inventors have further recognized and appreciated that distributed systems frequently have a need to offer high availability of the data, even as the underlying computing machines used to implement the distributed system may themselves occasionally fail. This applies not only to the transactional data maintained in partitions by data nodes (also referred to as replica nodes) on the distributed system, but also to configuration information stored on master nodes, which relates the partitions of the data store to the data nodes on which the data is replicated.

Accordingly, in some embodiments of the invention, the distributed system has multiple data nodes for storing data and multiple master nodes for storing configuration information. Data may be stored in partitions, each of which may be replicated by a set of data nodes within the distributed system. Even though the data nodes replicating the partition are unreliable, transactional consistency is assured using quorum-based processing. If a quorum of the data nodes in a current configuration agree on the current configuration, a data node that is part of that quorum can provide a reliable copy of the data for the partition.

Each partition may be periodically reconfigured to utilize a different set of data nodes or change the partition's primary node. Reconfiguration may be done, for example, in response to changes in the distributed system such as the loss or addition of data nodes.

To facilitate quorum-based identification of the data nodes in a partition at any given time, operations that establish or reconfigure the current configuration may also be implemented using quorum-based processing. When a new configuration for a partition is to be established, the data nodes in that new configuration do not “commit” the activation command until a quorum of the nodes in the new configuration respond with an indication that they are able to commit the command. Similarly, when a current configuration is to be deactivated, the nodes in the current configuration do not commit the deactivate command until a quorum of nodes in the current configuration respond that they can commit the deactivate command. In this way, when a reconfiguration occurs, there will be a quorum of nodes with the new configuration and not a quorum of nodes with the old configuration.

Regardless of the process by which the nodes are reconfigured, a configuration manager may store configuration information for the partitions of data nodes. Additionally, the configuration manager may execute programs that select a set of data nodes to store each partition. Though, the manner in which sets of data nodes are selected to store a partition is not critical to the invention and any suitable mechanism may be used. The configuration manager may also be implemented as a set of nodes, in exemplary embodiments referred to herein as master nodes.

The set of master nodes, also referred to as the master cluster, maintains configuration information that identifies the data nodes storing replicas of each partition and other information that may be used in accessing that data, such as an identity of the primary node in each partition. The set of master nodes constituting the master cluster may also change from time to time. Quorum-based processing may also be used to identify the current configuration of the master cluster. As with data nodes, changes to the current configuration of the master cluster may be performed with quorum-based operations.

In some embodiments, the configuration information in the master cluster may be stored as a database mapping the partitions to the data nodes on which they are replicated. In some exemplary embodiments described herein, such a database is described as a global partition map (GPM). The GPM may further include information about the status of each partition, such as which nodes are alive, which node is the primary node for each partition, the configuration version of each partition and whether the node is currently involved in a process of reconfiguring the nodes on which the partition is replicated.

The GPM may be treated as a partition stored on the master cluster. One of the nodes in the master cluster may be designated as the primary node for the GPM partition. Master nodes, like the data nodes of the distributed system in general, may be individually unreliable and occasionally fail. So long as a quorum of master nodes agrees on the current configuration of the master cluster, any master node within that quorum can provide reliable information on the GPM.

However, hardware failures or other events may cause a loss of integrity of the master cluster. In response, the master cluster may be rebuilt to restore that integrity. When the integrity of the master cluster is lost, the master cluster may be rebuilt, including regenerating the GPM, from information stored by the data nodes of the distributed system.

The master cluster may be rebuilt in response to a triggering event, such as when the primary master node is lost or a quorum of the master nodes is cannot be accessed to verify that a particular master node from which a GPM is available contains an accurate replica of the current GPM. In some embodiments, when a replica for any partition sends a message, it includes a configuration version for the partition which can be cross checked with the GPM. An inconsistency between the GPM and the configuration version indicated by the message may also trigger reconfiguration of the master cluster. Though, the specific events that are regarded as triggering events is not critical to the invention. For example, in some embodiments, loss of the primary node may not necessarily trigger rebuilding of the master cluster. If a quorum of master nodes in the current configuration is available, even though the primary node is not, it may be possible to replace the primary master node with another node that contains a replica of the current configuration. Accordingly, it should be appreciated that the trigger events described herein are exemplary and different or additional events may trigger a rebuild.

Regardless of the conditions under which a rebuild is to be initiated, a rebuild may entail erasing from all of the master nodes the current configuration information and regenerating that information based on messages received from data nodes. A new primary master node also may be selected as part of the rebuild. Other master nodes may be designated as secondary master nodes in the new configuration of the master cluster and replicas of the current configuration information, derived from the messages from the data nodes, can be stored in both the primary and secondary master nodes.

In some embodiments, the selection of secondary nodes may be made by programming on the primary master node. Additionally, the primary master node may collect and process messages from the data nodes to derive the current GPM. Though, in other embodiments, an external component may operate as a configuration controller that designates the primary and secondary nodes and collects messages from the data nodes.

Selection of a primary master node may entail considerations that are different than for the selection of secondary master nodes. In the embodiments described, processing is employed such that a single master node is designated as the primary master node and all other master nodes recognize that master node as the primary. In some embodiments, such processing may entail configuring the master nodes in a token ring. The master nodes in the token ring may have an order, such as based on the order in which they are passed the token around the ring. Based on this order, a master node at a predetermined location in the ring may be designated as the new primary master nodes, allowing a master node to be uniquely identified. In some embodiments, the new primary master node is selected as the master node with a token value of 0. However, any suitable mechanism may be used to uniquely identify a master node in the token ring. Also, any other suitable approach, whether or not a token ring is established, may be used to uniquely identify a master node as the primary master node in the new master cluster.

Before rebuilding the GPM, any existing data related to the map may be deleted by members of the master cluster. This process may be performed by deleting the GPM from all the master nodes of the prior master cluster and/or all the master nodes to make up the new cluster or all of the master nodes, or in any other suitable way. To rebuild the GPM, the nodes in the distributed system may each provide a message to one or more of the master nodes (e.g., the primary master node) indicating information from which the master nodes can reconstruct the GPM, such as the partition replicated by the node, a configuration version of the partition, and the set of data nodes for the partition. The messages sent by the nodes to the master cluster may be automatically sent on a periodic basis, sent in response to a request from the master cluster or other device acting as a reconfiguration controller, or sent as part of a system reset. Though, any suitable mechanism may trigger the nodes to send the reporting message to the master cluster. In some embodiments, the messages may be generated by the nodes using their own respective local partition maps. If a data node replicates more than one partition, the node may provide the above information for each partition.

The messages from the data nodes are received by the master cluster (e.g., the primary master node) and processed to identify a current version of the configuration for each partition. The configuration version of a partition may be identified when a quorum of the data nodes identifying themselves as part of the current configuration agree upon the configuration version. If a quorum is achieved for multiple configuration versions of the same partition, the more recent configuration version is activated in the GPM. In some embodiments, the more recent configuration version will be identifies as the configuration version with the highest numerical representation.

In some embodiments, data/information related to reconfiguration of nodes, (the nodes are associated with a distributed system that implements dynamic quorums of read/write conditions) is reconstructed via a reconstruction component. In one aspect, the reconstruction component enables storing replicating partial copies of the information across the distributed system itself. Such distributed segments can then be employed to reconstruct content of the central management system in a consistent manner. Accordingly, the reconstruction component can reconstruct the central management component contents, including the global partition map, from various locations on the system—wherein the central management component/configuration component can be treated as a cache. Moreover, scalability can be provided via protocol partitioning of the central management component (e.g., employing a same protocol as employed to make other parts of the system highly available). Likewise, employing a central management component for leadership election for the rest of the system allows for flexibility and scale, (typically not afforded if using conventional consensus based leadership election algorithm.)

In a related aspect, the configuration manager component can be replicated to a number of master machines that form the master cluster. Each of these nodes can interact with a respective reconfiguration agent with which the local instance of the Configuration Manager interacts. Moreover, the primary reconfiguration agent for the master cluster can be selected by a reliable consensus algorithm, which can be provided by the communication layer and the old and new configuration membership sets are determined by system configuration.

Accordingly, the reconstruction component can replicate the configuration manager component, and hence enable the configuration manager component to be readily available even in the loss of less than a quorum of master cluster machines. Put differently, the subject innovation enables restoration of the configuration manager component contents from various portions of the distributed system of nodes.

In a related aspect, partition related information can be restored from the replicas that are part of the more recent configuration for that partition. As part of the reconfiguration algorithm, each replica stores its local view of what is latest, or latest proposed, configuration for the partition. Since a configuration becomes active when a write quorum of replicas accept the new configuration, the subject innovation can determine which configuration is the most recent by identifying a configuration where a write quorum of replicas report that particular configuration as the latest. (This configuration is typically guaranteed to be the latest, assuming nodes cannot be rolled back in time, because there can only exist one such configuration since the current configuration must be deactivated before a new configuration is activated. The deactivation of the current/old configuration effectively destroys that configurations ability to form a quorum.)

According to a further methodology, when a catastrophic loss on the master cluster is detected, the system initiates a configuration manager rebuild by initially destroying any partial information left on the master cluster machines (since some machines can actually survive). The methodology subsequently requests each machine in the cluster/configuration of nodes to send its respective most current (e.g., latest) configurations for the partitions of which they hold replicas—wherein the configuration manager component receives such status messages. Each of the messages enable the configuration manager component to learn about partitions that existed in the system, the replicas on a particular machine, replicas on other machines that were known to the reporting replica, and machines known to the reporting machine that may not have reported their status. The configuration manager component can render a partition active again when it has received a write quorum of messages where the replicas for the partition report the same latest configuration, wherein such quorum depends on the configuration itself. Hence, as long as a write quorum of replicas for latest configuration of a partition report and there was no reconfiguration active during the catastrophic loss—then the system can ensure an automatic recovery of the partition. Likewise, if a reconfiguration was active up to a read quorum of the old configuration, then a write quorum of the new configuration can typically be required to ensure accurate restoration (although fewer reports suffice depending on the phase of the reconfiguration.)

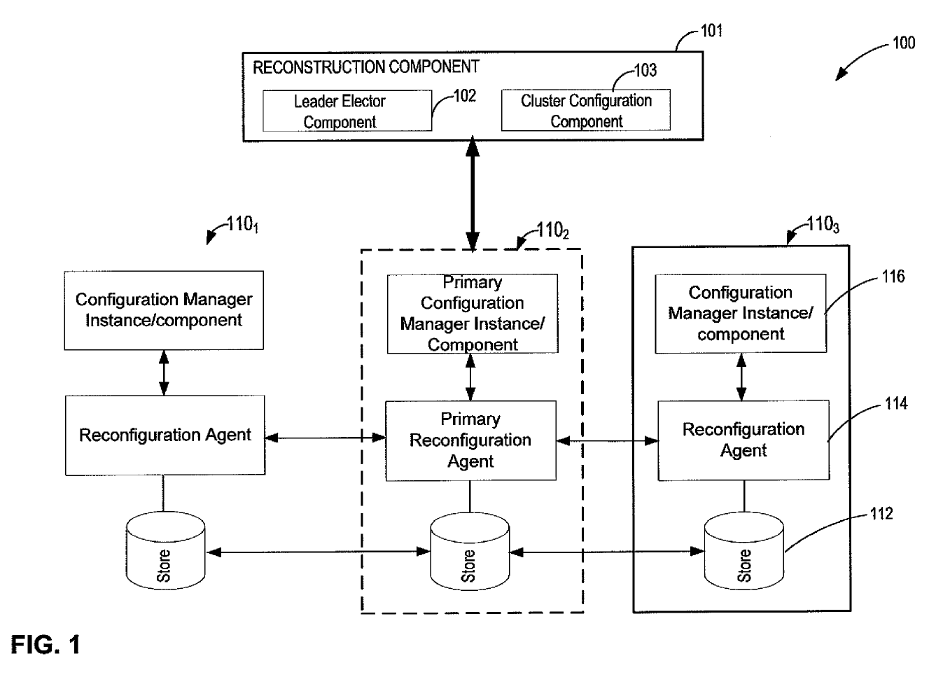

FIG. 1 illustrates a block diagram for a configuration manager 100 that employs a reconstruction component 101, which enables reconstructing information related to reconfiguring members of a distributed system. Such reconstruction component 101 can further be associated with a leader elector component 102 and a cluster configuration component 103, which can facilitate designation/operations associated with a primary (e.g., active) configuration manager instance/components. In one aspect, the reconstruction component 101 enables replicating partial copies of the information across the distributed system itself. Such distributed segments/pieces can then be employed to reconstruct contents of the central management system in a consistent manner. Accordingly, the reconstruction component 101 can reconstruct central management component contents from various locations on the system, wherein the central management component/configuration component can be treated as a cache. Moreover, scalability can be provided via protocol partitioning of the central management component (e.g., using a same protocol as employed to make other parts of the system highly available). In addition, employing a central management component for leadership election for the rest of the system allows for flexibility and scale, which is typically not afforded if using conventional consensus based leadership election algorithm.

Reconstruction component 101 may be implemented in any suitable way. In some embodiments, reconstruction component 101 may be in a computer device coupled to master nodes, 110₁, 110₂ and 110₃ over a network. Such a computer device may be programmed with computer-executable instructions that monitors for events, as described above, that may trigger a reconstruction of the configuration manager as described above. When such an event is detected, reconstruction component 101 may also issue commands and received responses that control the reconstruction process.

In some embodiments, reconstruction component 101 may additionally perform functions that control the primary nodes to establish that at least a subset of the available master nodes is configured to replicate a current version of the configuration information held within configuration manager 100. However, such control functions may alternatively or additionally be implemented in any suitable components.

In the embodiment illustrated, reconstruction component 101 is shown as a component separate from each of the master nodes. Though, it should be appreciated that reconstruction component 101 may be implemented in any suitable hardware, including in a primary master node.

FIG. 1 illustrates that configuration manager 100 is distributed across multiple master nodes. Here three master nodes, 110₁, 110₂ and 110₃ are shown. However, any suitable number of master nodes may be employed in a system and some or all of which may be configured at any given time to constitute a configuration manager.

In the embodiment illustrated, each of the master nodes 110₁, 110₂ and 110₃ is shown to be implemented with the same hardware. Such a configuration is provided for simplicity of illustration and each master node may be implemented with any suitable hardware or hardware components. However, taking master nodes 110₃ as illustrative, each master node may contain a data store 112, implemented in any suitable computer storage media, in which configuration information may be stored. Additionally, a master node may contain a reconfiguration agent 114 and a configuration manager component 116. In some embodiments, reconfiguration agent 114 and configuration manager component 116 may be implemented as computer executable instructions executed on a processor, such as may exist in a server or other computer device hosting a master node.

In operation, configuration manager component 116 may manage the configurations of the data nodes in a distributed database to which configuration manager 100 is coupled via a network. Management operations may include tracking active nodes in a partition to ascertain the number of active data nodes replicating the partition and adding data nodes to a configuration if there are an insufficient number of data nodes. In addition, configuration manager component 116 may perform other actions related to managing the partition, including providing information to other components accessing the database with information on data nodes from which data in one or more partitions can be obtained. Configuration manager component 116 may also perform other actions associated with a configuration manager as is known in the art or any other suitable actions.

In operation, reconfiguration agent 114 may interact with similar reconfiguration agents in other master nodes to ensure that each master node in a master cluster maintains a consistent replica of the configuration information. For example, when a change is made to information on one node, the reconfiguration agent on that node may distribute change information to reconfiguration agents on other nodes. However, it should be recognized that functions of a master node need not be implemented in two components as shown. All functions may be implemented in a single component or in more than two components.

As noted above, at any given time, one of the master nodes may be designated as the primary master node. The primary node may perform all control functions of the configuration manager and initiate all changes to the configuration information stored in the configuration manager. Other master nodes in the current configuration may receive such changes and make corresponding changes to maintain a consistent replica. In the embodiment illustrated, master node 1102 is the current primary node.

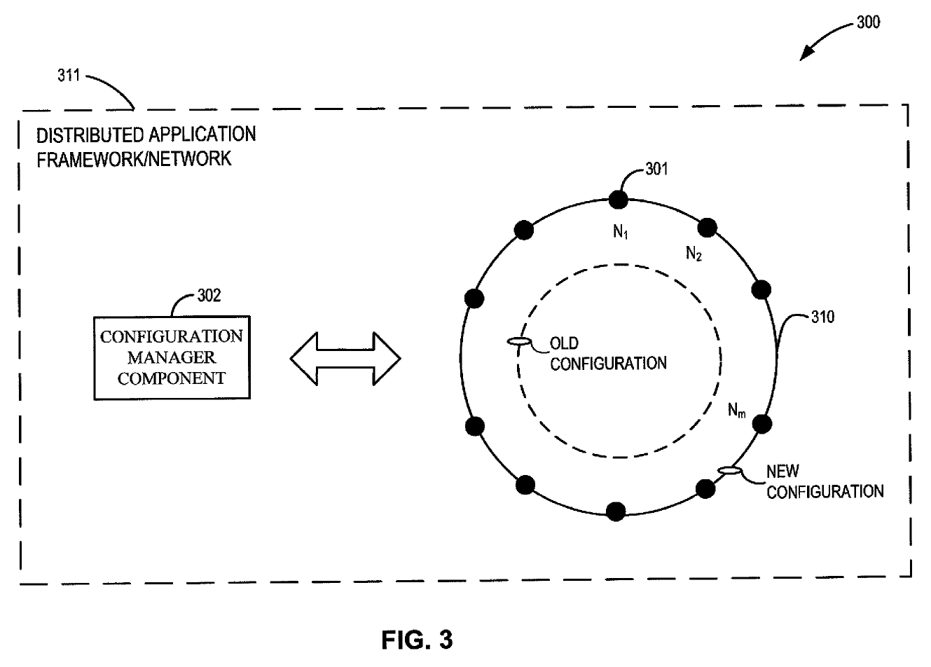

A master node may be selected to act as the primary node in any suitable way. In some embodiments, the master node is designated by a network administrator. Though, as described in connection with FIG. 3, below, an automated technique for selecting a primary master node may also be employed.

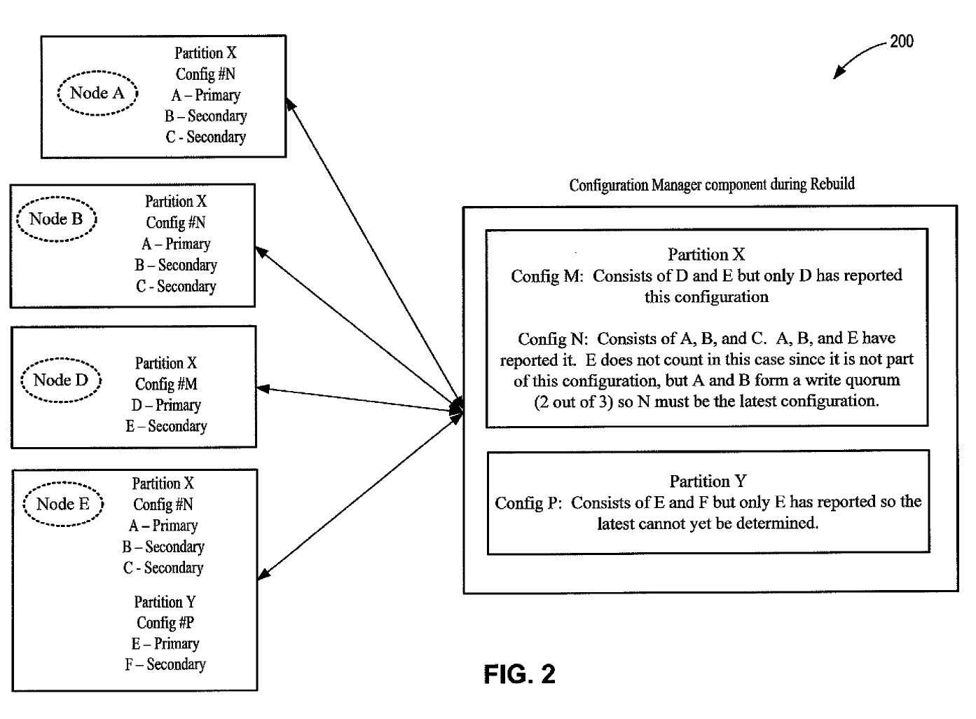

FIG. 2 illustrates a block diagram for a system 200 in which a configuration manager can be reconstructed according to an exemplary aspect. As illustrated in FIG. 2, each of the data nodes stores information about a configuration to which it has been assigned. At the time a data node is assigned to a configuration and receives a current copy of data being maintained by the distributed system, the information stored in that data node is up-to-date. The data in each data node may represent a partition of a database. In some embodiments, a database may contain a single partition such that each data node that is part of the current configuration contains a full copy of the database. In other embodiments, though, the database may contain multiple partitions and each data node may store only a subset of the database.

Regardless of how much of the database is stored in an active node, over time, due to hardware failures or other causes, one or more data nodes may not receive updates to the replicated data or the configuration. Accordingly, though the information stored in the data node itself may indicate that the node is up-to-date, that information may actually be incorrect. Accordingly, a quorum-based approach may be used for identifying data nodes that agree on the current configuration of the database. FIG. 2 provides an example of a manner in which quorum-based processing may be used to identify a current configuration based on information read from multiple nodes of the distributed system. Though, it should be appreciated that this information need not be read in response to a command initiated by a configuration manager, reconstruction component or other component. In some embodiments, this information is provided from the data nodes in response to a system restart or other event.

In the example shown in FIG. 2, for partition X of data (e.g., a segment/replica of data) configuration M consists of data node D and data node E, and yet as illustrated only data node D has reported such configuration. Likewise, configuration N consists of data nodes A, B, and C—wherein A, B, and E have reported such configuration. It is noted that data node E does not count in this scenario, as this node is not part of such configuration; but still A and B form a write quorum (2 out of 3)—hence; configuration N should in fact represent the latest configuration.

The configuration version and data node information for the latest configuration version are shown recorded as a global partition map in the configuration manager. This configuration information could have been stored in the configuration manager as the data nodes were configured. However, as illustrated in FIG. 2, this configuration information may be derived from messages sent by the data nodes, each identifying the information it has stored indicating the current configuration for each partition for which data is stored on the data node. In this way, the configuration information can be recreated based on messages from the data nodes.

FIG. 3 illustrates an approach by which a set of nodes can be organized to uniquely identify a node as a primary node. Such an approach may be used to automatically identify a master node to act as a primary master node.

FIG. 3 is a block diagram of a system 300 that implements a configuration manager component 302 in conjunction with a plurality of nodes as part of a distributed environment such as a ring 310—which can be reconstructed in accordance with an aspect of the subject innovation. The configuration manager component 302 can reconfigure members of a distributed system of nodes (e.g., servers) from an old configuration to a new configuration, in a transactionally consistent manner by implementing dynamic quorums based read/write conditions, which mitigate data loss during such transformation. Such quorum can represent a predetermined number, wherein an addition of the read quorum and the write quorum exceeds number of nodes for the configuration (e.g., the read and write quorums of a given configuration overlap). Though, similar processing may be used to create a new configuration, even without an old configuration, and may be used, for example, if a catastrophic failure has created a need to reconstruct the configuration manager.

As illustrated in FIG. 3, in general, when a first node N₁ 301 comes up in a ring 310, it can create a token that covers the entire number space, and can be referred to as the initial token creation. Subsequently, a token can ideally only be transferred among the nodes (Nₜ to Nₘ where m is an integer), so that typically, no two nodes can have overlapping tokens at any time For example, in a simplest form an administrator can explicitly indicate whether a node is a first node.

After the initial creation of the token, such a token needs to be split whenever a new node joins in the ring and requires a merger when an existing node leaves the ring and therefore gives up its token to some other node(s). Typically, the ring 310 is associated with a federation that can consist of a set of nodes that cooperate among themselves to form a dynamic and scalable network, wherein information can be systematically and efficiently disseminated and located. Moreover, the nodes participating in a federation can be represented as a sorted list using a binary relation that is reflexive, anti-symmetric transitive, total, and defined over the domain of node identities. For example, both ends of the sorted list can be joined, thereby forming a ring 310. Such provides for each node in the list to view itself as being at the middle of the sorted list. In a related aspect, the list can be doubly linked such that a node can traverse the list in either direction. Moreover, a one-to-one mapping function can be defined from the value domain of the node identities to the nodes themselves. Such mapping function accounts for the sparseness of the nodes in the value domain when the mapping is not tight.

As such, every node participating in the federation is assigned a natural number that is between 0 and some appropriately chosen upper bound, inclusive, and that that range does not have to be consecutive (e.g., there can exist gaps between numbers assigned to nodes). Such number assigned to a node acts as its identity in the ring. The mapping function accounts for gaps in the number space by mapping a number being positioned in between two node identities to the node having an identity that is numerically closest to the number. Accordingly, by assigning each node a uniformly distributed number, it can be ensured that all segments of the ring are uniformly populated. Moreover and as described in detail infra, nodes that indicate the successor, predecessor, and neighborhood computations can be performed efficiently using modulo arithmetic.

In such an arrangement, routing consistency can be achieved via assignment and ownership of tokens. Typically, a node can accept a message only when it has an ownership token on the ID to which the message is destined. As explained above, a token contains a consecutive range of IDs and every token has an owner. A token in transit is considered not to exist until it is accepted by a node. Moreover, the range of two tokens must in general be disjoint—wherein all token ranges are disjoint, and a token can be split into two adjacent tokens. In addition, two or more adjacent tokens can be merged into a single token, wherein a node does not accept a message without a corresponding token. Additionally, a node must typically own a token that includes at least its own ID. A node owning a token is referred to be in the routing stage and can also be referred to as a routing node. A routing node owns only a single token, or, a single range of IDs, for example. Eventually, the token for an ID will be owned by a routing node that is closest to that ID (e.g., the liveness property). Token transfer should be synchronized with the transfer of data that is stored at any ID in the range of the token. More precisely, token transfer can typically occur only after data transfer is completed. In general, a node that owns a routing token can be referred to as a routing node.

The interactions described above associated with organizing nodes into a ring as illustrated in FIG. 3 may be performed by any suitable components. In some embodiments, messages may be sent and received under control of the available master nodes in a system. In other embodiments, the interactions may be performed under control of an interconnection fabric, implemented by components that interconnect the master nodes in a network.

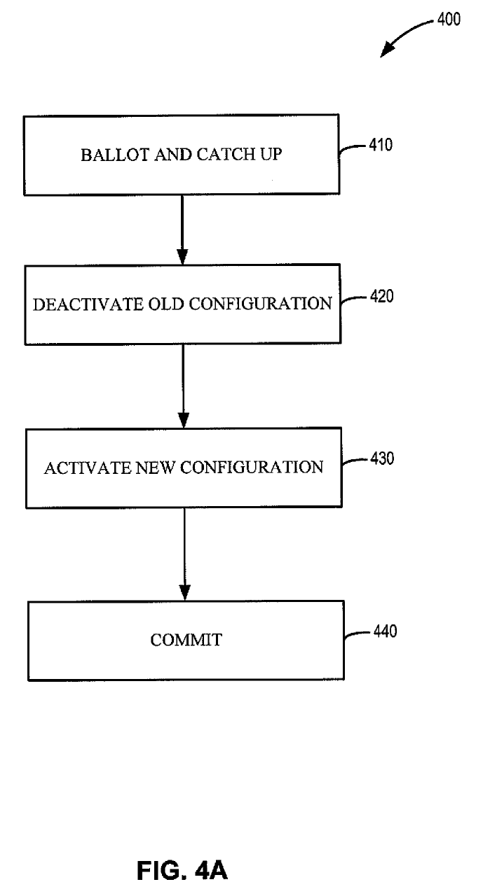

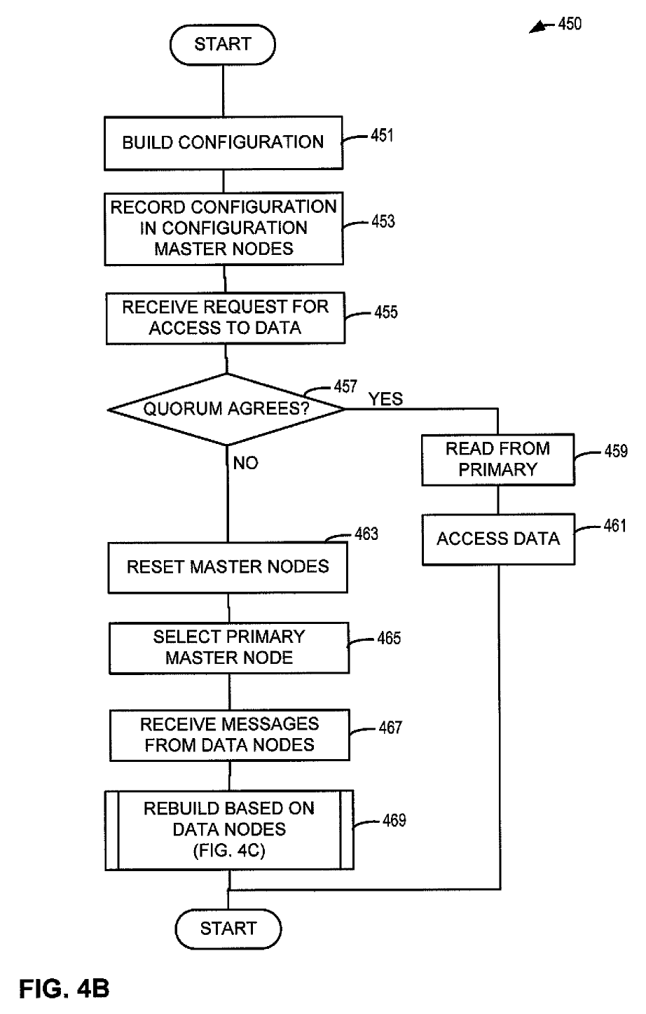

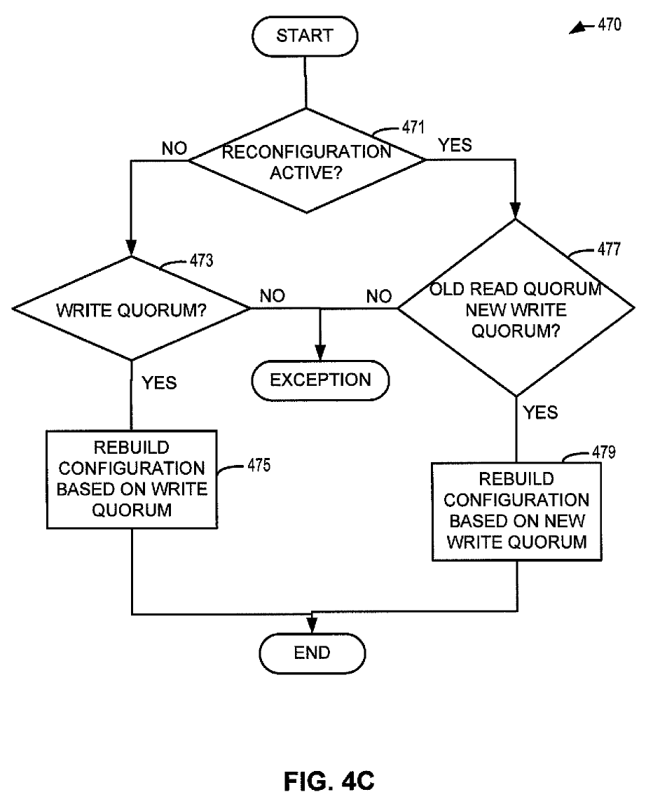

FIG. 4A illustrates a related methodology 400 for various stages of configuring a network of nodes. The process may be employed to configure data nodes storing a partition of a database. Though, a similar process may be used to configure master nodes into a master cluster.

Each partition of data in the distributed system is stored on a set of data nodes. One of the data nodes may be designated as the primary replica for the partition. The remaining data nodes for the partition may be designated as secondary replicas. Upon receipt of a reconfiguration request, a reconfiguration agent on the primary replica can initiate deactivation for an old or existing configuration, and supply a further activation of the new configuration (e.g., ensuring that any transactions whose commits were acknowledged to the client will be retained by the new configuration; and transactions which had not committed or whose commit had not been acknowledged can either be committed or rolled back.) Such can include implementation of four stages, namely:

Phase 1: Ballot and Catch-up at 410

During this phase the primary replica of the partition proposes a globally unique ID for the new configuration of the partition. Upon acceptance by a quorum of replicas of both the old and new configurations, such ID is guaranteed to be greater than any previously accepted ID for this replication unit. The proposed ID is sent to all replicas in both the old and new configurations each of which accepts or rejects the ID based on whether it is greater than any ID they have observed previously. Accordingly, if a replica accepts such ID it can further notify the primary replica of its latest transaction sequence number and halts acceptance of new transactions.

Alternatively, if a replica rejects the proposed ID, the primary picks are new higher ID and restarts Phase 1. Once a quorum of replicas from both the old and new configuration has accepted the proposed ID, the primary directs the replicas in the new configuration to start catching up so that the transactional consistency and data safety requirements are maintained across the reconfiguration. Such can involve a mixture of catch-up and transaction rollbacks on individual replicas. Moreover, the process is guaranteed to result in a quorum of replicas agreeing on the current state for the content and provides Atomicity, Consistency, Isolation, Durability (ACID) properties across the reconfiguration. Phase 1 can be complete once at least a quorum of replicas in the new configuration has been caught up.

Phase 2: Deactivation of Old Configuration at 420

During this phase the primary replica coordinates the deactivation of the old configuration. The purpose of deactivation is to guarantee that it is never possible to find two sets of replicas R1 and R2 such that R1=R2 and each replica r1 in R1 claims that configuration C1 is the latest configuration and R1 forms a write quorum of C1 and each replica r2 in R2 claims that configuration C2 is the latest configuration and R2 forms a write quorum of C2; unless C1=C2. Moreover, a deactivation message can be sent to each replica in the old configuration. Each of the replicas can accept the deactivation if it matches the latest ballot proposal it has accepted. This phase is complete when a read quorum of replicas acknowledges the deactivation.

Phase 3: Activation of New Configuration, at 430

During such phase the primary replica coordinates the activation of the new configuration. A purpose of activation is to guarantee that a write quorum of the new configuration knows that the configuration has been activated before changes to the content of the replication unit are allowed. Such can ensure that any content changes can be lost only if quorum of nodes are lost. The activation message can further be sent to each replica in the new configuration. Each of these replicas can accept the activation if it matches the latest ballot proposal it has accepted. Such phase is complete when a write quorum of replicas in the new configuration has accepted the activation. At this point the new configuration is active and useable.

Phase 4: Commit at 440

Such stage is an optional phase for committing the reconfiguration—since at end of Phase 3 the old configuration has been deactivated and the new configuration has been activated. Yet, such is known only to the primary replica and from a global outside-of-system perspective. Accordingly, such commit phase distributes this knowledge throughout all interested parties in the distributed system, namely to each replica in the old and new configurations as well as the Configuration Manager.

FIG. 4B is a flow diagram of a method 450 for managing a distributed database system. At step 451, a configuration of the database is built. Specifically, the database may be organized as one or more partitions. Each partition of the database is replicated by a set of assigned data nodes. Initial configuration may be performed manually or may be automated in any suitable way. Because the partitions may be reconfigured, a configuration version may be used to identify the current configuration of each partition.

As part of the initial configuration, a set of master nodes forms a master cluster within the distributed system. At step 453, the configuration of the database system is recorded as configuration information by the master nodes of the master cluster. In some embodiments, the configuration information maps each partition to the data nodes on which it is replicated. The configuration information may further include information about the status of each partition, such as which nodes are alive, which node is the primary node for each partition, and the configuration version of each partition. The configuration information may be implemented, for example, as a global partition map.

At step 455, the distributed system receives a request to access data from a partition. The request may, for example, be a request to read data from a partition or write data to a partition. The request may be received, for example, from a client computer wishing to access the database of the distributed system.

To service the request, the distributed system may determine which data node contains data to service the request. If the configuration manager contains a reliable copy of the configuration information, it can determine which data node will service the request from the configuration information stored by the master nodes. At step 457, the distributed system determines whether a quorum of the master nodes exists such that the quorum identifies the same configuration of master nodes as holding the current configuration information for the distributed database.

If it is determined that a quorum exists, the primary node may provide the requested information. Accordingly, method 450 continues to step 459. At step 459, the primary data node for the partition identified by the quorum of master nodes is read. At step 461, the requesting client is provided the data accessed from the primary data node. Similarly, if a write request is made by the client, the requested data to be written is provided to the primary data node.

If however, at step 457, it is determined that a quorum of the master nodes does not exist, the system may determine to rebuild the master cluster. Processing at step 457 may alternatively or additionally include other processing that may lead to an identification of a trigger condition, such as a catastrophic hardware failure, for rebuilding the configuration manager. In this scenario, processing branches to step 463.

At step 463, the master cluster is reset. The reset may entail erasing from all of the master nodes the current configuration information in preparation for rebuilding the configuration manager.

At step 465, a primary master node is selected. In some embodiments, the current primary master node, if alive, is designated as the primary. In other embodiments, processing is used to uniquely identify a master node as the new primary master node. For example, the master nodes may be configured into a token ring as described above in connection with FIG. 3. In such an embodiment, a token is passed from node to node, assigning ordered positions to the master nodes. The new primary master node is selected as the master node with position 0.

At step 467, messages from data nodes are received. In this embodiment, the messages are received at the new primary master node. However, the messages may be received and processed in any suitable component. Each data node may provide a message to the master cluster indicating a configuration of the database. For example, a data node may report to the master cluster the partition or partitions of the database which it replicates and the configuration of each partition. Namely, the data node may specify a configuration version of the partition, an indication of the partitions primary replica, an indication of any secondary replicas for the partition, and a status of the partition. The status may indicate, for example, that the partition is active on the data node or that the data node is part of a new configuration of the partition that has not yet been activated.

Though, it should be appreciated that not every possible data node may send such messages. For example, some subset of the data nodes, such as only active data nodes or only data nodes that store configuration information indicating that the node is part of the current configuration for at least one partition, may send such messages. Moreover, it should be recognized that only a quorum of data nodes in a current partition are required to send messages for the current configuration to be identified. Accordingly, the component receiving the messages at step 467 may collect messages until it receives messages identifying a quorum or may collect messages for some suitable period of time, without waiting to receive a message from every possible data node.

Regardless of how many messages are received, processing may proceed to step 469. At step 469, the configuration information is rebuilt based on information provided from the data nodes. The rebuild process is described with reference to method 470 shown in FIG, 4C. In some embodiments, steps 463, 465, 467, and 469 are performed by a reconstruction component, such as reconstruction component 101 (FIG. 1).

FIG. 4C is a flow diagram of a method 470 for rebuilding configuration information from data nodes in a distributed system. Though FIG. 4C illustrates processing for a single partition, the method 470 may be performed for each partition of the database in the distributed system using the information provided from the data nodes. In this way, configuration information relating to the entire database may be reconstructed.

At step 471, it is determined whether the partition was undergoing reconfiguration at the time that the messages were sent, meaning that the partition was being migrated from one set of data nodes to another. Status information provided by a data node for the partition may be used to determine whether the partition is undergoing reconfiguration. Such processing may be useful, for example, to prevent errors from reconstructing a partition using information that was in an inconsistent state because of a catastrophic error to the configuration manager during the reconfiguration process.

If it is determined at step 471 that the partition is not being reconfigured, method 470 proceeds to step 473 where it is determined if a write quorum of the data nodes for the configuration version of the partition exists. The presence of a write quorum may be determined from the messages reported by the data nodes. If those messages contain a set of messages, sent by different nodes, consistently identifying a set of nodes as the current configuration, that set possible may be the current confguration. If a quorum of the data nodes identified as being the current configuration send messages indicating that they are active as the current configuration, that set of nodes may be deemed to represent the current configuration. At block 473, the messages received at block 467 may be searched to find a set of messages meeting the criteria for identifying the current configuration.

If a write quorum exists, method 470 continues to step 475 where the current configuration of the partition as verified by the write quorum is written into the configuration manager as the current configuration information.

If, however, a write quorum is not found at step 473, it may not be possible to rebuild the configuration information. Accordingly, an exception condition may be identified, which may be handled in any suitable way. In some embodiments, the processing of FIGS. 4B and 4C for reconstructing configuration information may be performed automatically. However, exception processing may require manual intervention.

Returning, back to step 471, if it is determined at step 471 that a reconfiguration of the partition is active, method 470 proceeds to step 477. At step 477, it is determined whether a read quorum of an old configuration of the partition and a write quorum of the new configuration is present. In some embodiments, only whether a write quorum of the new configuration exists is checked at step 477.

If the appropriate quorums exist, the distributed database may be deemed to have been in a consistent state at the time of the event, such as a catastrophic failure of the configuration manager, that triggered the rebuild of the configuration manager. Accordingly, at step 479 the configuration information is updated in the master cluster with the new configuration of the partition as verified by the write quorum of the new configuration. The new quorum may optionally be activated.

Failure to obtain the appropriate quorums at step 477 results in an exception. The exception may indicate, for example, that distributed database was in an inconsistent state such that manual intervention or other exception processing is required.

As used in this application, the terms “component”, “system”, are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

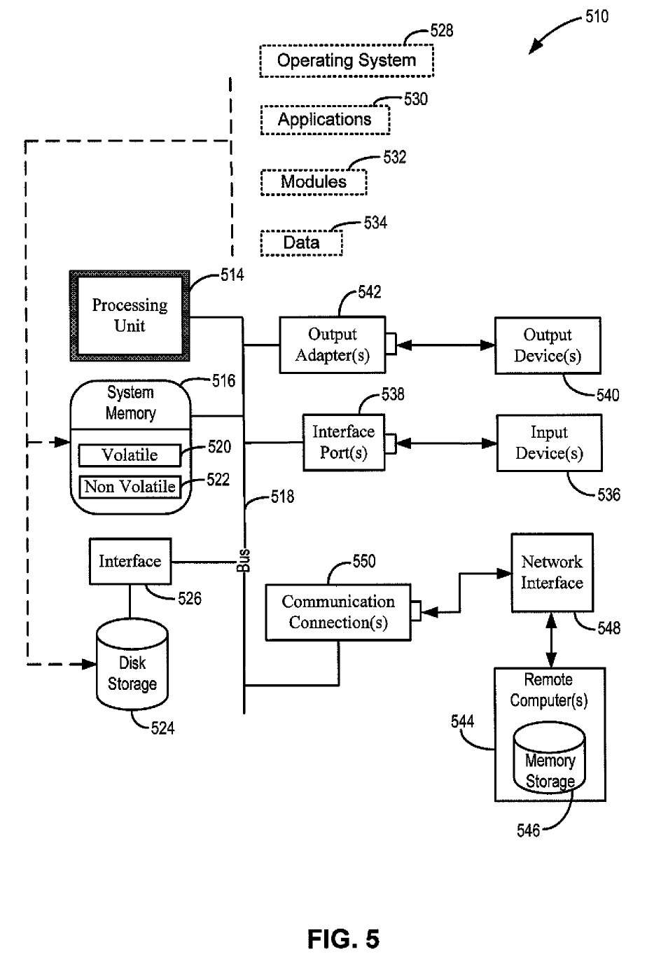

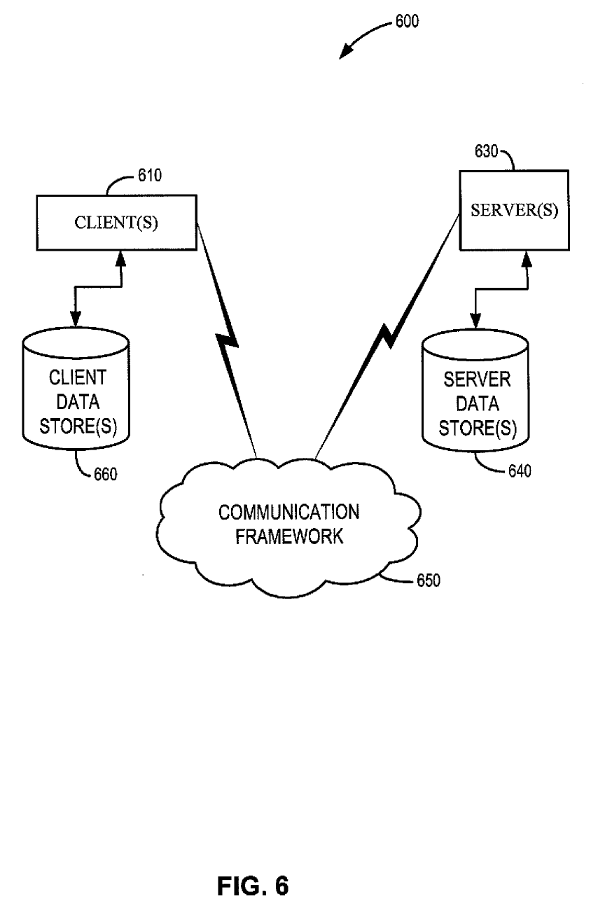

In order to provide a context for the various aspects of the disclosed subject matter, FIGS. 5 and 6 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 5, an exemplary environment 510 for implementing various aspects of the subject innovation is described that includes a computer 512. The computer 512 includes a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structures) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 516 includes volatile memory 520 and nonvolatile memory 522. The basic input/output system (BIOS), containing the basic routines to transfer information between elements within the computer 512, such as during start-up, is stored in nonvolatile memory 522. For example, nonvolatile memory 522 can include read only memory (ROM), programmable ROM (PROM), electrically programmable ROM (EPROM), electrically erasable ROM (EEPROM), or flash memory. Volatile memory 520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM). Synchlink DRAM (SLDRAM), and direct Rambus RAM (DRRAM).

Computer 512 also includes removable/non-removable, volatile/non-volatile computer storage media. FIG. 5 illustrates a disk storage 524, wherein such disk storage 524 includes, but is not limited to, devices like a magnetic disk drive, floppy disk drive, tape drive, Jaz drive, Zip drive, LS-60 drive, flash memory card, or memory stick. In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in suitable operating environment 510. Such software includes an operating system 528. Operating system 528, which can be stored on disk storage 524, acts to control and allocate resources of the computer system 512. System applications 530 take advantage of the management of resources by operating system 528 through program modules 532 and program data 534 stored either in system memory 516 or on disk storage 524. It is to be appreciated that various components described herein can be implemented with various operating systems or combinations of operating systems.

A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port may be used to provide input to computer 512, and to output information from computer 512 to an output device 540. Output adapter 542 is provided to illustrate that there are some output devices 540 like monitors, speakers, and printers, among other output devices 540 that require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a personal computer, a server, a router, a network PC, a workstation, a microprocessor based appliance, a peer device or other common network node and the like, and typically includes many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to computer 512. The hardware/software necessary for connection to the network interface 548 includes, for exemplary purposes only, internal and external technologies such as, modems including regular telephone grade modems, cable modems and DSL modems, ISDN adapters, and Ethernet cards.

FIG. 6 is a schematic block diagram of a sample-computing environment 600 that can be employed for implementing nodes as part of a federation, in accordance with an aspect of the subject innovation. The system 600 includes one or more client(s) 610. The client(s) 610 can be hardware and/or software (e.g., threads, processes, computing devices). The system 600 also includes one or more server(s) 630. The server(s) 630 can also be hardware and/or software (e.g., threads, processes, computing devices). The servers 630 can house threads to perform transformations by employing the components described herein, for example. One possible communication between a client 610 and a server 630 may be in the form of a data packet adapted to be transmitted between two or more computer processes. The system 600 includes a communication framework 650 that can be employed to facilitate communications between the client(s) 610 and the server(s) 630. The client(s) 610 are operatively connected to one or more client data store(s) 660 that can be employed to store information local to the client(s) 610. Similarly, the server(s) 630 are operatively connected to one or more server data store(s) 640 that can be employed to store information local to the servers 630.

Having thus described several aspects of at least one embodiment of this invention, it is to be appreciated that various alterations, modifications, and improvements will readily occur to those skilled in the art.

As an example of a possible variation, in an exemplary embodiment described above, a quorum of nodes was selected to be a majority of the nodes. Other implementations are possible, with the quorum being either greater or less than a majority of the nodes. Moreover, the quorum may change over time for a configuration as nodes fail or go off-line.

As an additional example, the present application uses as an example a system in which loss of the primary master node is regarded as a catastrophic failure that triggers a rebuild of the configuration manager. It is not a requirement that the loss of a primary master node trigger a rebuild of the configuration manager. If one or more replicas of the current configuration information can be reliably identified, the configuration manager can be reset based on this information.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of obtaining configuration information defining a current configuration of a plurality of data nodes storing replicas of a partition of a database, the method comprising:
operating at least one processor to perform acts comprising:
receiving a plurality of messages, each message generated by a data node of the plurality of data nodes and indicating a version of the configuration of the database for which the data node is configured and a set of data nodes configured in accordance with the indicated configuration to replicate the partition stored on the data node;
identifying, based on the received messages, a selected set of data nodes, the selected set of data nodes being a set identified in at least one of the plurality of messages for which a quorum of the data nodes in the set each generated a message indicating the same configuration version and the selected set of data nodes; and
storing as a portion of the configuration information an indication that each data node of the selected set is a data node storing a replica of the partition.

2. The method of claim 1, wherein the plurality of messages comprise messages from at least half of the data nodes configured to store the partition, and the data nodes forming the quorum comprise at least half of the data nodes storing the partition.

3. The method of claim 1, further comprising:
sending a request to the plurality of data nodes storing the database for each to provide a respective message among the plurality of messages.

4. The method of claim 3, wherein the storing comprises:
storing the configuration information in a configuration manager, the configuration manager comprising a plurality of master nodes in a master cluster.

5. The method of claim 4, further comprising:
in response to detecting an event indicating a loss of integrity of the configuration information stored in the master cluster:
deleting the configuration information from master nodes of the master cluster; and
selecting a master node among the plurality of master nodes as a new primary master node.

6. The method of claim 1, wherein a second message among the plurality of messages generated by a second node indicates the second node has a second partition with a first configuration version for said second partition, and identifying data nodes for the second partition, the method further comprising:
inspecting any messages among the plurality of messages from the data nodes for the second partition; and
determining a quorum of data nodes for the second partition does not exit.

7. The method of claim 1, further comprising activating the partition in the configuration information.

8. The method of claim 7, wherein the identified quorum of data nodes for the partition comprises all of the data nodes for the partition.

9. A database system storing a database comprising a plurality of partitions, the system comprising:
a plurality of computing nodes; and
a network communicably interconnecting the plurality of computing nodes,
wherein, the plurality of computing nodes comprise:
a plurality of data nodes organized as a plurality of sets, each set comprising nodes of the plurality of data nodes storing a replication of a partition of the plurality of partitions; and
a plurality of master nodes, each master node storing a replication of configuration information, the configuration information identifying the data nodes in each of the plurality of sets and a partition of the plurality of partitions replicated on the nodes of each of the plurality of sets.

10. The system of claim 9, wherein
the data nodes for a first partition of the plurality or partitions is each configured to generate a first message identifying the first partition as being replicated on said node, a configuration version of the first partition, and identifying each of the data nodes for the configuration version of the first partition, and
the plurality of master nodes is configured to perform a method in response to a reconfiguration triggering event, the method comprising:
receiving a plurality of the first messages generated by the data nodes for the first partition;
identifying a quorum of data nodes for the first partition, the data nodes forming said quorum each having a same configuration version for said first partition; and
updating the configuration information to indicate, for said first partition, the configuration version of the first partition and the data nodes for said first partition.

11. The system of claim 10, wherein the reconfiguration triggering event is a loss of quorum among the plurality of master nodes.

12. The system of claim 10, wherein the reconfiguration triggering event is a loss of a primary master node among the plurality of master nodes.

13. The system of claim 12, wherein:
each of the plurality of master nodes are assigned a token on a communications ring; and
a new primary master node among a plurality of master nodes remaining after the loss of the primary master node is identified as a master node having a token spanning a predetermined value.

14. The system of claim 13, wherein the new primary master node performs the method.

15. The system of claim 10, wherein identifying the quorum by the plurality of master nodes comprises:
comparing the configuration version of the first partition identified by the first message from one of the data nodes to the configuration version indicated by the first messages from one or more other data nodes, the one or more other data nodes being the data nodes identified by the first message from the one of the data nodes as being the data nodes for the configuration version of the first partition.

16. A computer-readable storage medium comprising computer-executable instructions that, when executed by a computer system, perform a method, the method comprising:
identifying the computer system as a primary node for a master partition;
deleting any existing data for a global partition map;
receiving a plurality of messages from at least a subset of a federation of nodes, each message generated by a node among the subset and indicating for said node a partition replicated on said node, a configuration version of the partition, and data nodes for the partition;
identifying a quorum of data nodes for a first partition, the data nodes forming said quorum each having a same configuration version for said first partition; and
updating the global partition map to indicate, for said first partition, the configuration version of the first partition and the data nodes for said first partition.

17. The computer-readable storage medium of claim 16, wherein the method further comprises:
analyzing each of the plurality of messages to determine if the configuration version for the partition replicated by the respective node is part of a quorum for said partition.

18. The computer-readable storage medium of claim 16, wherein identifying the computer system as the primary node comprises determining the computer system has a token spanning a predetermined value.

19. The computer-readable storage medium of claim 16, wherein the method further comprises:
sending a request to a plurality of nodes in the federation for each to provide a respective message among the plurality of messages.

20. The computer-readable storage medium of claim 16, wherein identifying the quorum of data nodes comprises:
comparing the configuration version of the first partition identified by the first message from one of the data nodes to the configuration version indicated by the first messages from one or more other data nodes, the one or more other data nodes being the data nodes identified by the first message from the one of the data nodes as being the data nodes for the configuration version of the first partition; and
determining that at least half of the data nodes for the configuration version of the first partition have the same configuration version for said first partition.
